(19) United States
(12) Patent Application Publication
(10) Pub. No.: US 2014/0297430 A1
(43) Pub. Date: Oct. 2, 2014

(54) SYSTEM AND METHOD FOR FACILITATING THE DISTRIBUTION OF ELECTRONICALLY PUBLISHED PROMOTIONS IN A LINKED AND EMBEDDED DATABASE

(71) Applicant: Reach Labs, Inc., Northridge, CA (US)

(72) Inventors: Justin Rezvani, Northridge, CA (US); Jeffrey Thomas Weintraub, Rialto, CA (US); Jonathan Rezvani, Northridge, CA (US); Bryan Christopher Burns, Rancho Cucamonga, CA (US); Steven Christopher Vazquez, Rancho Cucamonga, CA (US)

(73) Assignee: REACH LABS, INC., Northridge, CA (US)

(21) Appl. No.: 14/296,411

(22) Filed: Jun. 4, 2014

Related U.S. Application Data
(60) Provisional application No. 61/981,044, filed on Apr. 17, 2014.
(60) Provisional application No. 61/898,123, filed on Oct. 31, 2013.
(60) Provisional application No. 61/898,135, filed on Oct. 31, 2013.

(51) Int. Cl. G06Q 30/02; G06F 17/30

(52) U.S. Cl. CPC G06Q 30/0276; G06F 17/30014
USPC 705/14.72; 707/748

(57) ABSTRACT

A system and method are provided for facilitating large-scale distribution of electronically published promotions. Users are registered in connection with a social media account and input data regarding their preferred content categorical affinities describing the topics of their published content. Registered users may upload identification data to a server, authorize an administrator element to access the identification data, view or select multiple marketing campaigns to participate in and upload a photo and caption as a submission. A calculation is performed to determine the user's offer price for a campaign and a rank valuing their ability to reach a particular target audience. The administrator element may approve, deny or request edits made to the user's submission. Once approved, a user may electronically publish the submission on a social media network. The server confirms the publication and measures its performance by tracking the engagement data of the particular content item.

### RELATED APPLICATIONS

This application claims the benefit of U.S. Provisional Application No. 61/898,123 filed on Oct. 31, 2013, U.S. Provisional Application No. 61/898,135 filed on Oct. 31, 2013, and U.S. Provisional Application No. 61/981,044 filed on Apr. 17, 2014, the contents of each of which are incorporated by this reference in their entirety for all purposes as if fully set forth herein.

### TECHNICAL FIELD

The present invention relates generally to the creation and distribution of electronically published promotions and related advertisements. More particularly, the invention concerns a system and method to facilitate the process of generating published visual content promotions in a linked and embedded database.

### BACKGROUND

In the past, online marketing was typically limited to desktop or laptop computers. Businesses wishing to promote their brand messages, product and/or service focused their marketing campaigns where people consumed media the most. Previously, consumers spent an average of 2.22 hours a day consuming media from their desktop or laptop computer. Today, given the developments in mobile computer technology and its increasing popularity, more and more people are consuming media on mobile devices that ever before. Currently, users now consume the same if not more from their mobile device when compared to desktop and laptop computers. Today on average, people check their mobile device 150 times a day and spend 2.21 hours consuming media. Additionally, greater and greater numbers of people are frequently creating, sharing and exchanging media using their mobile device via specific visual content sharing social media sites. Such popular social media sites can have 75 million daily active users who post 55 million photos and engage with the content via 1.2 billon likes per day.

For businesses, this change in consumer behavior means marketing strategies must be adapted to reach these new age consumers. One such strategy is influencer marketing. Influencer marketing is an innovative approach to reach new audiences and consumers on social media sites. An influencer is a user that generates content and shares that content to their audience through a specific social media site. An influencer is a user with a consistent message or theme throughout their shared content, a loyal following of users and high audience engagement. An example of influencer marketing is when a business partners with the Influencer, to serve as a brand advocate to promote the business' product or service to the Influencer's audience.

The current state of influencer marketing methods and systems is such that a business has to reach out via email or personal contact to an individual influencer, without any insight to the audience that follows that influencer. Reaching out to each individual influencer via email or personal contact is a time-consuming and complex process. Time is spent gathering identification information about the influencer and about their audience, waiting for the influencer to respond back to messages, communicating and clarifying campaign directions, coordinating the form and content of a promotion, reviewing and editing photo and caption submissions, and scheduling the publications of approved content. Currently, there is no scale-able solution in place to reach hundreds of influencers in an intuitive way through their mobile device. What is needed are systems and methods to facilitate more efficient and effective generation, publishing and distribution of promotions that are 100% brand-safe by influential people on visual content sharing specific social media sites.

Additionally, there is no current scale-able solution in collecting data from an influencer. It also follows that collecting information about the audience following the influencer to develop an audience profile analysis is as time-consuming and complex. The audience of a influencer consists of followers who are users of a visual content sharing social media site that have linked their account to the influencer's account. Followers can view the content items posted by an influencer. Some influencers can have a million followers or more. Data relating to each and every one of these followers is important because it allows a business to more efficiently target their marketing campaign to a specific audience, in certain categorical affinities, and ultimately to the consumer they would like to promote their product or service to. Categorical affinities are categories of interest that are associated with the topical content of the influencer which include, for example, entertainment, movies, fitness, automotive, etc.

Previously, methods of influencer profile analysis have attempted to rank influencers by using data associated with the frequency of select interactions between users. For example, past methods include counting interactions based upon retweets, replies, mentions, likes, shares, event invitations, the mutuality of friends between users, and how many followers an account may have following them. Although this strategy can provide an influencer profile analysis that is better than if there was no ranking at all, the resultant of such data for a business seeking an audience profile analysis is insufficient. What is often neglected is the quality of the interaction. Large and popular social media sites can be overrun with hundreds of unimportant and unwanted “bot” accounts that camouflage the more relevant and influential ones. “Bot” accounts allow user's to artificially inflate their account's relevance by inducing likes or mentions to draw greater attention to their account or to any advertisements contained therein. Hence, the method of ranking by counting interactions is vulnerable to “spamming” techniques such as “bot” accounts. For this reason, some accounts often contain commercial biases that should not be considered top quality interactions. Although many social media sites are designed to avoid such shams, poorly conceived mechanisms fail to hamper the success of bots.

Also, the commonly-known idea of link counting has been used as a simple method for determining the importance of an influencer. Presently, methods conventionally classify the number of likes or number of followers as a number of backlinks; backlinking to an influencer's content item or account. The backlink rank r(A) of an influencer which has n backlinks is

r(A)=n

When a linked database, such as this simple example, is relatively homogeneous in importance and quality, it is valid to assume that an influencer that is highly cited should be of greater interest than another user's account having only one or two backlinks. However, when a social media site does not classify interactions, such as comments, as backlinks but as embedded HTML elements, the data pulled from a linked database can result in extreme variations in relevance and quality of user account data. For these instances, ranking by counting backlinks is overly simplistic. For example, backlink ranking will give the same rank to an influencer that is backlinked once by an obscure user as it would give that same influencer when backlinked once by a highly cited and engaged influencer's account.

Currently, sufficient methods may not be available to rank an influencer's audience as well as accurately analyze the profile of the audience in relation to a business' relevant categorical affinities. What is needed is an improved system and method of influencer and audience profile analysis to more accurately rank the commercial value of an influencer and their audience in real-time us, particularly based on certain categorical affinities relevant to a business' target audience as well as taking in to consideration not only link data between users but also embedded HTML element data.

### SUMMARY

An exemplary embodiment of a computer-implemented method for facilitating the distribution of electronically published promotions may comprise a number of steps. For example, a server element may be provided to communicate between at a least a user and an administrator element. A software application (“app”) may be provided for download via a network accessible app store, the app configured to be downloaded to a computing device of a user. The app may be configured to enable the user via a graphical user interface to (in this or an alternative order): (a) upload to the server element user identification data unique to the user, (b) authorize the administrator element to access the user identification data, (c) view or select at least one marketing campaign associated with a merchant, the marketing campaign having campaign directions, (d) create or select at least one content item which relates to a product or service of the merchant, and which includes visually detectable media and a caption that are consistent with the campaign directions, and (e) upload to the server element the at least one content item for submission.

Exemplary embodiments of a computer-implemented method may further comprise recording, in machine readable memory, the user identification data for access by the administrator element. The at least content item uploaded by the user may be stored, in machine readable memory, for access by the administrator element. On or both of a user rank and campaign offer price may be computed, via a processor element, based for example, on the user identification data and the content item. A graphical administrator interface may be provided which is configured to enable the administrator element to (in this or an alternative order): (i) upload to the server element merchant identification data and marketing campaign information data, the marketing campaign information data including, for example, the campaign directions and a required link, (ii) enter or approve the campaign offer price, (iii) create a said marketing campaign incorporating at least part of the marketing campaign information data, (iv) send the created marketing campaign to the user, (v) receive the at least one content item uploaded by the user, (vi) review the at least one content item uploaded by the user, (vii) approve at least one said reviewed uploaded content item, and (viii) send at least one said approved uploaded content item to the user with said required link for publication.

In the exemplary embodiment described above, the server element may be configured to confirm that the said approved uploaded content item was published on at least a social media network server element, and, measure the performance of the said approved uploaded content item. Moreover, the graphical administrator interface may be further configured to enable the administrator element to send a payment to the user. In certain instances, the administrator element may be authorized to access a second user's identification data, the second user having engaged with the first user. The marketing campaign information data may contain a second link to a document associated with the product or service of the merchant, wherein the at least one content item created by the user incorporates the second link. Additionally, the step of computing may preferably involve a comparison between at least a portion of the user identification data and at least one content categorical affinity entered by the administrator element.

An exemplary method for ranking a plurality of linked and embedded documents may comprise, for example, obtaining a plurality of documents, calculating a rank of each document, and assigning the ranks to those documents. In the step of obtaining a plurality of documents, for example: (a) at least some of the documents may be linked documents, (b) at least some of the documents may be linking documents, (c) at least some of the documents may be both linked documents and linking documents, (d) each of the linked documents may be pointed to by a link in one or more of the linking documents, (e) at least some of the documents may have embedded elements, (f) at least some of the documents may have embedding elements, (g) at least some of the documents may have both embedded and embedding elements, and (h) each of the embedded documents may contain an element from one or more of the embedding documents. The rank of each of the linked and embedded documents may be calculated based on ranks of the one or more linking or embedding documents. Assignment of a rank to the linked and embedded documents may be made according to their respective calculated ranks

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1 is a flow chart diagrammatically illustrating a method in accordance with one non-limiting embodiment of the present invention;

FIG. 2 is a block diagram diagrammatically depicting a system in accordance with one non-limiting embodiment of the present invention;

FIG. 3 is a first logic flowchart diagrammatically depicting an embodiment of a method in accordance with the present invention;

FIG. 3A is a second logic flowchart diagrammatically depicting an embodiment of a method in accordance with the present invention;

FIG. 4 diagrammatically illustrates a first portion of a Welcome page of an embodiment of a graphical user interface;

FIG. 5 diagrammatically illustrates a Sign Up page of an embodiment of a graphical user interface;

FIG. 6 diagrammatically illustrates a second portion of a Welcome page of an embodiment of a graphical user interface;

FIG. 7 diagrammatically illustrates an Add a Social Media Account page of an embodiment of a graphical user interface;

FIG. 8 diagrammatically illustrates a Your Social Media Account page of an embodiment of a graphical user interface;

FIG. 9 diagrammatically illustrates a user Profile page of an embodiment of a graphical user interface;

FIG. 10 diagrammatically illustrates a Campaigns page of an embodiment of a graphical user interface, whereby a user can view available campaigns to participate in;

FIG. 11 diagrammatically illustrates a Campaign Info page of an embodiment of a graphical user interface;

FIG. 12 diagrammatically illustrates a first portion of a Submit For Campaign page of an embodiment of a graphical user interface;

FIG. 13 diagrammatically illustrates a Submit Caption page of an embodiment of a graphical user interface;

FIG. 14 diagrammatically illustrates a second portion of a Submit For Campaign page of an embodiment of a graphical user interface;

FIG. 15 diagrammatically illustrates an Approved page of an embodiment of a graphical user interface;

FIG. 16 diagrammatically illustrates an Admin page of an embodiment of a Internet-enabled graphical administrator interface, whereby administrators can add and edit information regarding administrators;

FIG. 17 diagrammatically illustrates a Users page of an embodiment of a Internet-enabled graphical administrator interface, whereby administrators can view and edit information regarding users;

FIG. 18 diagrammatically illustrates a Campaigns page of an embodiment of a Internet-enabled graphical administrator interface, whereby administrators can view and edit information regarding campaigns;

FIG. 19 diagrammatically illustrates an Add Campaign page of an embodiment of a Internet-enabled graphical administrator interface;

FIG. 20 diagrammatically illustrates an Invite Users to Campaign page of an embodiment of a Internet-enabled graphical administrator interface;

FIG. 21A diagrammatically illustrates a diagram depicting the relationship between two pages that are linked by a like;

FIG. 21B diagrammatically illustrates a diagram depicting the relationship between two pages that have an embed element by comment;

FIG. 21C diagrammatically illustrates a diagram depicting the relationship between two pages that are linked by an @mention;

FIG. 21D diagrammatically illustrates a diagram depicting the relationship between two pages that are linked by a follow;

FIG. 22A diagrammatically illustrates a first portion of a diagram depicting the relationship between three User Account documents that are linked and embedded in accordance with an embodiment of the present invention;

FIG. 22B diagrammatically illustrates a second portion of a diagram depicting three User Account documents in a linked and embedded network, whereby the rank associated with each web page is illustrated in accordance with an embodiment of the present invention; and

FIG. 23 diagrammatically illustrates a logic flowchart depicting a probability estimation in accordance with one non-limiting embodiment of the present invention.

### DETAILED DESCRIPTION OF THE PREFERRED EMBODIMENTS

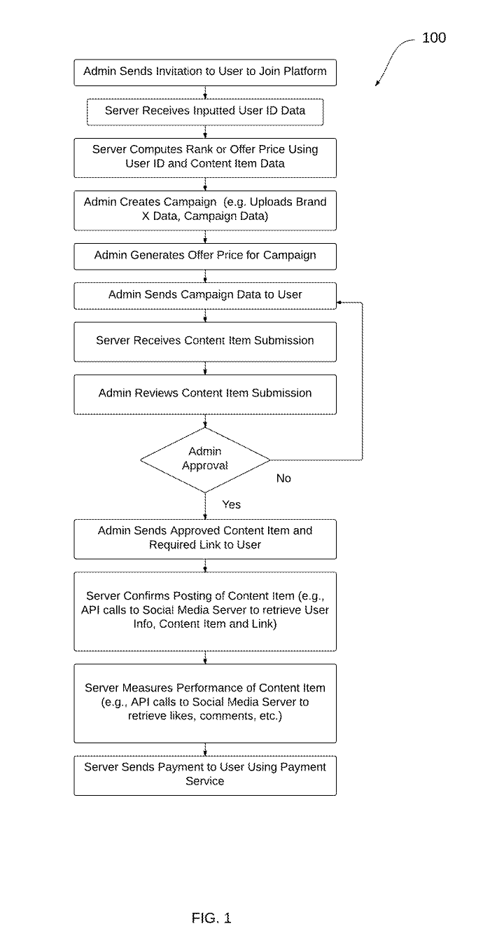

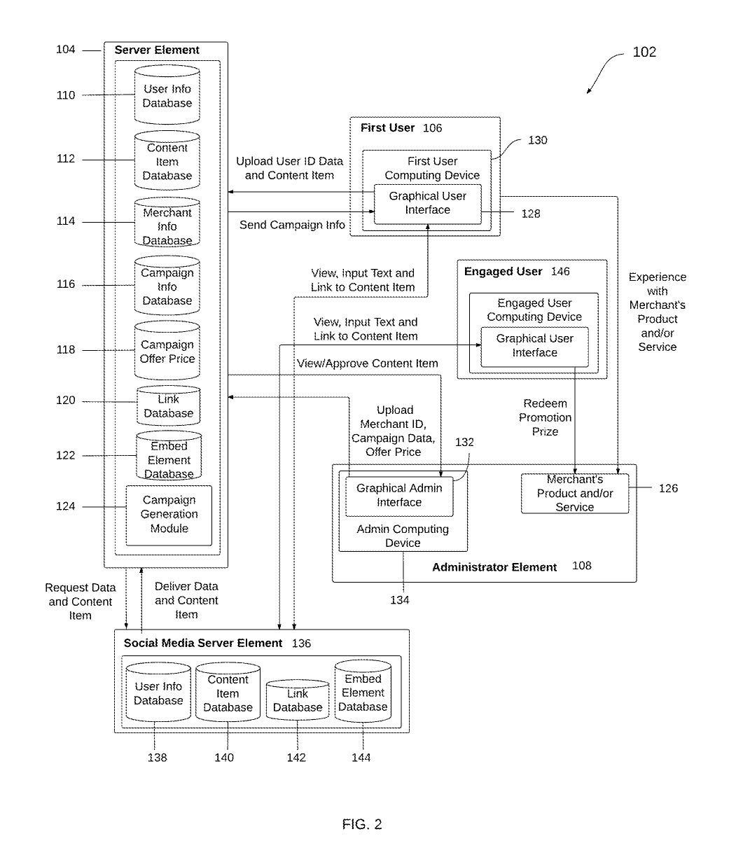

Referring now to the drawings, like reference numerals designate identical or corresponding features throughout the several views. Referring in particular to FIGS. 1-3, exemplary embodiments of a method 100 and system 102 for facilitating the distribution of electronically published promotions are illustrated. A server element 104 may be provided in communication between a first user 106 and an administrator element 108. Depending on the particular embodiment, the server element 104 may be comprised of one or more servers, which may or may not be collocated, either in the same rack, room or geographic location. In certain preferred embodiments, a server element may be, for example, one or more database servers, web servers, chat or instant message servers, file servers, print servers, a combination thereof, or the like. Depending on the particular embodiment, the server element may generally include or be connectedly associated with storage elements, such as, for example, one or more of a user information database 110, content item database 112, merchant information database 114, campaign information database 116, campaign offer database 118, link database 120, embed element database 122 and a campaign generation module 124.

The administrator element 108 may be a machine or a person administering the method 100 and system 102. Depending on the particular embodiment, the administrator element 108 may be a merchant, merchant's authorized representative, merchant's agent, a user, user's authorized representative or a user's agent. In preferred embodiments, an agent may be a person, business or machine authorized to act on another's behalf. In general, a user, such as a first user 106, who may be an influencer and may typically have some personal experience with a business, product or service 126, engages a respective graphical user interface 128 (GUI) provided for and displayed on a user computing device 130. Depending on the particular embodiment, a computing device 130 may be, for example, a personal computer, a desktop computer, a laptop computer or a mobile device such as a smart phone or tablet, and may be configured to present the graphical user interface 128 on a display element of the respective device. Depending on the particular embodiment, a graphical user interface may be or comprise, for example, a web-based interface, web user interface, touchpad, touch screen, command line interface, direct manipulated interface, computer keyboard, mobile device or smart phone keyboard, a combination thereof, or the like.

The graphical user interface 128 may be configured to enable the user to perform several steps. For example, the user 106 may upload to the server element 104 user identification data identifying the user into the user information database 110. Depending on the particular embodiment, user identification data may include, for example, information about the user, the user's type of account, the gender of the user, the content categorical affinities the user prefers to describe their content items, the number of posts by the user or the number of followers a user has, a combination of or the like. In preferred embodiments, the user's type of account may be an account classified as a parody, topical-based, or real person.

Depending on the particular embodiment, the content categorical affinities may, for example, include the topical categories the user prefers to post content about, for example, comedy, automotive, fashion, food, pets, art, architecture, teen topics, movies, a combination of, or the like. Further, the user 106 may authorize the administrator element 108 access to the user's identification data or content item data. Depending on the particular embodiment, the authorized content item data as contained in the content item database 112 may include previous or, if applicable, presently posted content item data, for example, the identification number of the media posted, the number of likes or comments a piece of content receives or links to other user accounts or web pages.

Depending on the particular embodiment, link data as contained in the link database 120 may correspond to, for example, likes made from one user to another user's content item, links signifying votes of approval for another user or content item, links used to follow another user (e.g., as a follower or as to following another user), links directing another user to another user's page (e.g., an “@mention”), links to a parent webpage (e.g., forward link), links from a subsidiary webpage (e.g., backlink), hypertext links, a combination thereof, or the like.

Depending on the particular embodiment, embed element data as contained in the embed element database 122 may correspond to, for example, the number of comments embedded as HTML element on a content item, the text of the comment embedded as HTML element, link script embedded as HTML element, user information embedded as HTML element, a combination thereof, or the like.

Moreover, the user 106 may view or select at least one marketing campaign 116 associated with a merchant's business, product or service. Depending on the particular embodiment, campaign information as contained in the campaign information database 116 may include directions relevant to the campaign directions, directions relevant to the caption, hyperlink or hashtag link. Moreover, the user may create or select at least one content item that includes visually detectable media or a caption by the user. Depending on the particular embodiment, the visually detectable media may be, for example, a photo, picture, or video. In certain embodiments, the user may create a content item by taking a photo or video with their computing device or by selecting a previously taken photo or video. In certain preferred embodiments, the caption by the user may include a hyperlink, hashtag link directing a user to another web page, or text relevant to the campaign directions, the merchant's business, product or service, a combination thereof, or the like. Further, the user may upload their identification data and content item to the server element 104 for recording and storage, respectively, where it may be accessible to the administrator element 108. In preferred embodiments, machine-readable memory may be comprised of one or more data storage devices.

Depending on the particular embodiment, a processor element may be provided, for example, to compute the rank or offer price of user 106. In certain preferred embodiments, a processor element may be, for example, one or more CPUs, microprocessors, network processors, communication processors, front-end processors, a combination thereof, or the like. Depending on the particular embodiment, the identification data and content item data of user 106 may be used, for example, to compute their rank or offer price. A graphical administrator interface 132 (GAI) may be provided for and displayed on an administrator computing device 134. Depending on the particular embodiment, a administrator computing device 134 may be, for example, a personal computer, a desktop computer, a laptop computer or a mobile device such as a smart phone or tablet, and may be configured to present the graphical administrator interface 132 on a display element of the respective device. Depending on the particular embodiment, a graphical user interface may be, for example, a web-based interface, web user interface, touchpad, touch screen, command line interface, direct manipulated interface, computer keyboard, mobile device or smart phone keyboard, a combination thereof, or the like.

The graphical administrator interface 132 may be configured to enable the administrator element 108 to upload to the server element merchant identification data as contained in the merchant information database 114. In certain preferred embodiments, the merchant identification data may be, for example, the name and contact information of a merchant, its subsidiary, parent entities, non-profit, brand, authorized representative or agent, information regarding the business, product, service, a combination thereof, or the like. Further, the administrator element 108 may upload to the server element 104 marketing campaign information as contained in the campaign information database 116. In certain embodiments, the marketing campaign information may include, for example, the name of the campaign, the impressions contracted to be delivered, the budget of the merchant, brand, authorized representative, agent, start and end dates, Federal Trade Commission disclosures, hypertext links, hashtag links, campaign directions, caption directions, a combination thereof, or the like. In preferred embodiments, the administrator element 108 may also decide whether to enter a computed campaign offer price 118 to the user or whether to require administrative approval before publication of the content item. Moreover, the administrator element 108 may be enabled to create a marketing campaign using a campaign generation module 124, incorporates at least part of the marketing campaign information data.

In preferred embodiments, the administrator element 108 may send the marketing campaign to the user 106 incorporating at least part of the marketing campaign information 116. For example, a user 106 may be invited by the administrator element to participate in the campaign upon being sent the marketing campaign information. The administrator element 108 may be enabled to receive, from the user 106, at least one uploaded content item, incorporating at least part of the marketing campaign information 116. Further, the administrator element 108 may be enabled to review at least one uploaded content item. In certain embodiments, the administrator element 108 may reject a photo or video, reject the caption associated with the photo or video, reject the entire content item submitted, or instruct the user to remedy the rejection by editing the photo, video or caption included in the content item. The administrator element 108 may be enabled to approve at least one content item uploaded by, for example, the user 106.

Further, the administrator element 108 may be enabled to send the approved content item with a required link to user 106 incorporating at least part of the marketing campaign information. In certain embodiments, the server element 104 may be provided to confirm the approved content item was published on at least one social media network server element 136. In preferred embodiments, the server element may be configured to communicate with a visual content specific social media network to confirm the publication of the content item by application programming interface (API) remote call the user information database 138, the content item database 140, the link database 142, and the embed element database 144. In certain embodiments, the server element 104 may be provided to measure the performance of the approved content item data.

Depending on the particular embodiment, the server element may be configured to measure the performance of (i.e., the engagement with) the content item by other users, for example, the number of likes the content item receives, the number of comments the content item receives, the text embedded by other users on to the content item, in a continuous or for a specific time frame referenced by a time stamp, a combination thereof, or the like. In preferred embodiments, the graphical administrator interface 132 may be configured to enable the administrator element 108 to send payments to the user. Depending on the particular embodiment, the payment may be, for example, in the form of cash, electronic fund transfer, redeemable codes, coupons, promotional products or services from a merchant's business, by electronic payment service, a combination thereof, or the like.

In certain embodiments, the administrator element 108 may have access to engaged user 146 identification data. In preferred embodiment, an engaged user may be a user who interacts with the first user, for example, by liking, commenting, following, backlinking, forwardlinking to or embedding element onto a first user's content item. In certain embodiments, the marketing campaign information may include a relevant link to a document associated with the merchant's product or service. Depending on the particular embodiment, a document may be, for example, a web document, web page, mobile page, user's profile page, content item hosting page, user's account, a combination thereof or the like.

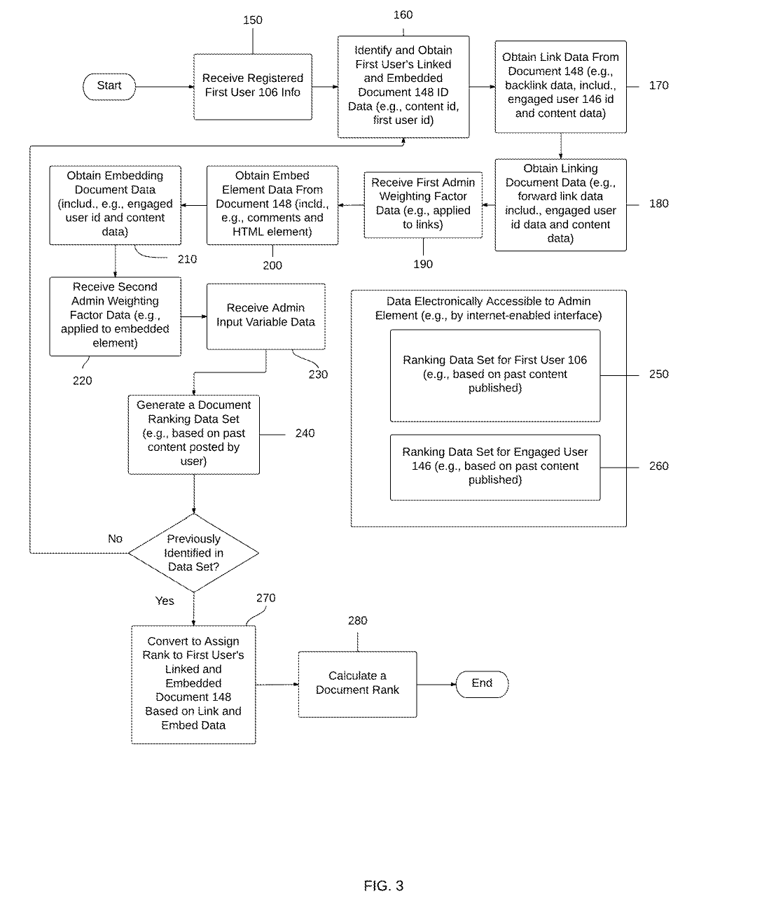

In order to calculate the rank or offer price data 118 of a user, a method for facilitating the distribution of electronically published promotions may comprise, for example, one or more steps as described below. FIGS. 3 and 3A illustrates one or more preferred embodiments of a method in accordance with the present invention. For example, referring to FIG. 3, in particular embodiments of systems and methods to calculate rank in accordance with the present invention, machine-readable memory may be configured for storage of first user data, linked document data, linking document data, first weighting factor data, embedded element document data, in combination thereof, or the like.

In step 150, data from a registered first user 106 maybe received and stored. In preferred embodiments, the registered first user data may include a first user identification data. Preferred embodiments may include a step 160, where a linked and embedded document 148 may be identified and link data obtained therefrom. In preferred embodiments, a linked and embedded document (e.g., the identified document 148 that has been liked and commented on) may include a content item page, user profile page that has been linked to by another user (e.g., corresponding as a following) or that has been embedded with comments in the form of HTML element (e.g., corresponding to being commented on).

As referred to in step 170, linked document data (e.g., link data from the identified document 148) may be obtained. In preferred embodiments, link data may correspond to the number of likes a user's content item page receives, the data associated with another engaged user who has followed the influencer user's account or the number of comments embedded on the web page, a link count from a second user document, a combination thereof, or the like.

Referring to step 180, data from a linking document may be obtained. In preferred embodiments, linking document data may correspond, for example, to the identification data from an engaged user that linked, liked or followed the first user's document 148 (e.g., content item page), or a forward link count to another engaged user's profile page. Referring to step 190, the server element may receive a first weighting factor data from the administrator element. In preferred embodiments, the first weighting factor may be a like weight factor multiplied by the number of likes. The like weight factor may be an integer, whole number, decimal or the like. In certain embodiments, the first weighting factor may correspond to a weighting factor as applied to links or links from followers requesting to follow the first user, and to a backlink or forward link amount, a combination thereof, or the like. As illustrated by step 200, embedded document data from the first user's document 148 may be obtained. In preferred embodiments, embedded document data may correspond to the number of comments or text elements embedded by another user or follower, for example, in the form of HTML element on the first user's content item page, the text or comment itself, or any combination thereof, or the like.

Referring to step 210, embedding document data may be obtained. In preferred embodiments, embedding document data may correspond with data related to an engaged user who commented on a influencer's content item page, which may include, for example, the engaged user's identification data, content item data, a combination of, or the like. As illustrated by step 220, the server element may receive a second weighting factor data. In preferred embodiments, the second weighting factor data may be a comment weight factor that may be multiplied by the number of comments to use for calculation. The comment weight factor may be an integer, whole number, decimal or the like. In certain embodiments, the second weighting factor may include a factor as applied to embedded elements, embedded HTML elements, a combination of, or the like. As referred to in step 230, the server element may also receive an input variable data. In preferred embodiments, input variable data may be provided by the administrator element and may correspond to a cost per mille constant (e.g., CPM, cost per 1000 impressions, expressed as an integer or decimal) or other cost per unit data, a combination of, or the like. An impression is typically defined as the measure of which a web page, web document or online advertisement contained therein is statistically likely to be seen by an individual, whether clicked on or not.

In certain preferred embodiments of systems and methods in accordance with the present invention, the processor element may be configured to communicate with the machine-readable memory by one or more logic applications executable by the processor element and containing instructions which, when executed by the processor element may be configured to generate a document ranking dataset, perform a step of assigning a rank and a step of calculating a rank. Referring to step 240 and depending on certain embodiments, a document ranking dataset may be electronically accessible to the administrator element and, for example, may include one or more of the following: a ranking data set 250 for the registered first user 106 corresponding to data from at least a previously published content item page, and a ranking data set 260 of at least a second user (e.g., an engaged user 146) corresponding to data from at least a previously published content item page.

In preferred embodiments, the first user ranking data set 250 may be, for example, based on data from the first user's past content item published, based on the past five content items the first user posted, based on a moving average of data from past content items posted by the first user, a combination of, or the like. In preferred embodiments, the engaged user ranking data set 260 may be, for example, based on data from the engaged user's past content items published, based on the past five content items the engaged user posted, based on a moving average of data from past content items posted by the engaged user, a combination of, or the like. As illustrated in step 270, the processor element may be configured to assign a rank to one or more linked and embedded documents based on ranks of the one or more linking document data or embedding document data.

Referring to step 280, the processor element may be configured to calculate a document rank based upon, for example, at least the ranking data set for the first user document, the ranking data set for at least the second user document, resulting in the adjusted rank of the first user's identified linked and embedded document 148. In preferred embodiments, linked and embedded documents may, for example, correspond to an influencer's content item having received links to it, likes or comments and may be ranked based on it's comparative ranking one or more linking or embedding documents which may, respectively, correspond with the engaged user's content items having also received links to it, likes or comments, respectively. In further embodiments, the linked document data may include the second (e.g., engaged) user's identification data and content item data. In preferred embodiments, the linking document data may include the second (e.g., engaged) user's identification data and content item data.

Referring to FIG. 3A for illustration, preferred embodiments may provide one or more methods to calculate an offer price or rank in accordance with the present invention. For example, one or more particular embodiments may use link data 170 (e.g., the number of followers or following) and divide the number of followers of user 106 by the number of users following to generate an impression ratio. Preferred embodiments may use link data 170 (e.g., the number of likes) and multiply this by the first weighting factor 190 (e.g., an integer) and add the resultant to embed element data 200 (e.g., the number of comments) multiplied by the second weighting factor 220 (e.g., an integer) further dividing the total by the number of followers of the user 106 to calculate an engagement rate.

In certain embodiments, a vertical engagement rate may be calculated as the average engagement rate of other users identified as being within similar or the same or selected content categorical affinities. Preferred embodiments may divide the vertical engagement rate by the engagement rate to result in an engagement multiplier. Further, preferred embodiments may use data from step 230 (e.g., an initial price variable expressed an integer or a CPM variable expressed a decimal or integer constant) multiplied by the number of followers and further multiplied by the engagement multiplier to calculate a final offer price or user ranking.

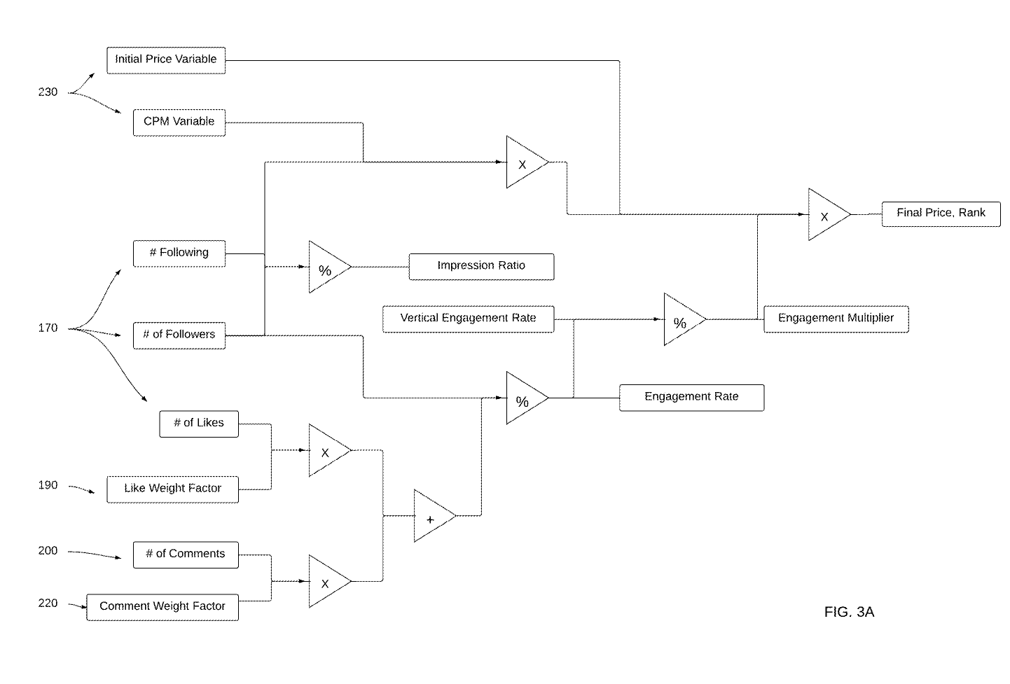

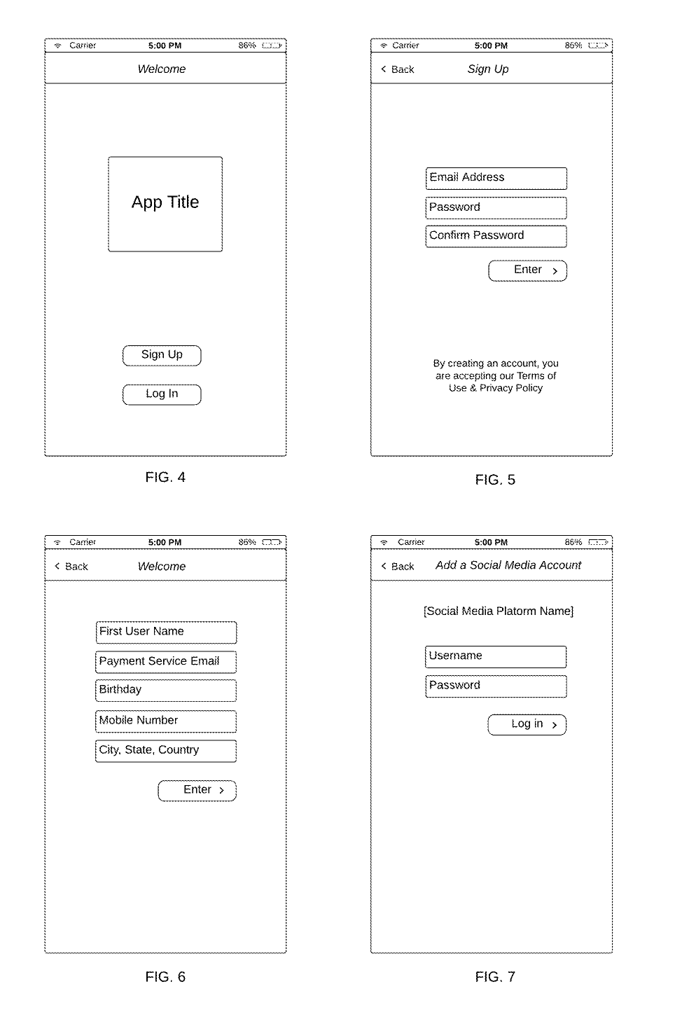

Referring to FIG. 4-6 for illustration, preferred embodiments may provide a graphical user interface enabling a user to upload identification data to the server element. For example, a first portion of a Welcome page may be provided to allow a user to sign up or login in to their account. In preferred embodiments, the user may create an account and enter their log-in information, which, for example, may include an e-mail, password, name, payment service e-mail, birthdate, mobile number, and geographic location. The user may authorize the administrator element to access certain identification data by accepting the Terms of Use and Privacy Policy prompts.

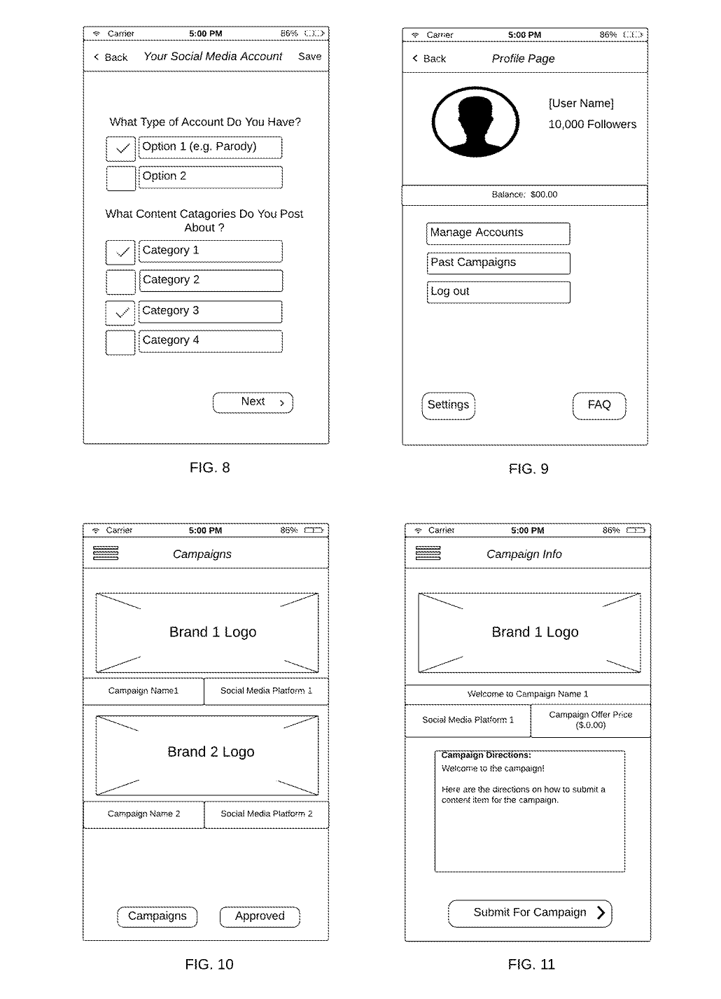

Referring to FIG. 7 for illustration, preferred embodiments may provide an Add a Social Media Account page where a user may input their username and password to add one or many associated social media accounts from particular social media platforms. Referring to FIG. 8 for illustration, preferred embodiments may provide a Your Social Media Account page where each user may input information regarding the type of account they have (e.g., Parody, Real Person, Topical, etc.). Further, preferred embodiments may enable a user to input information regarding the type of content categorical affinities the user posts about.

Referring to FIG. 9 for illustration, preferred embodiments may provide a user Profile page where each user may view identification information including, for example, their username, the number of followers associated with their account and their balance, a combination thereof, or the like. Preferred embodiments may also enable a user to manage their accounts, review past campaigns, log out from their account, access account settings, frequently asked questions (e.g., FAQ) a combination thereof, or the like. In certain embodiments, a graphical user interface may also be configured to display monthly balance of completed campaign earnings may be accessible to the user.

Referring to FIGS. 10-11 for illustration, particular embodiments may provide a Campaigns Available page where a user can view or select at least one marketing campaign associated with a merchant. In preferred embodiments, the graphic user interface will display, for example, a merchant's brand logo, trademark, slogan, promotional art, a combination thereof, or the like. The Campaign page may also display the campaign name and the social media platform name to be posted on. Preferred embodiments may enable a user to click on the campaign's logo to learn more information regarding the campaign. Certain embodiments may also enable a user to select a CONTINUE button and view selected marketing campaigns.

Referring to FIG. 11, preferred embodiments may provide a Campaign Info page to enable the user to view the campaign offer price as well as Campaign Directions that explain the scope of the campaign chosen and a Submit For Campaign button the user can push to participate. In certain embodiments, the graphical user interface may also provide a Campaigns Available page where a user can read the campaign directions and push a button SUBMIT FOR CAMPAIGN to participate. Further embodiments may provide an Offer page where each user may be offered a certain price per photo or price per video to participate in a marketing campaign.

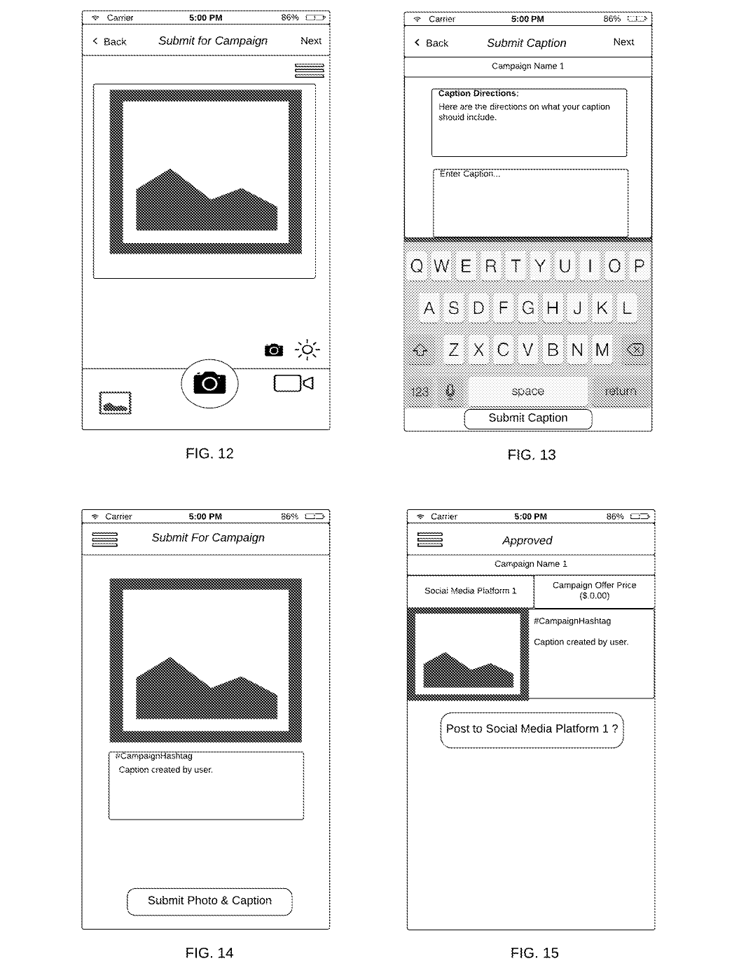

Referring to FIGS. 12-14 for illustration, particular embodiments may provide a first portion of a Submit For Campaign page where a user can create a content item by taking a photo, uploading a picture or recording a video using their computer device. In one alternative embodiment, a user may select a pre-existing photo or video. Further embodiments may have a second portion of a Submit Caption page whereby a user reads the caption directions and enters a caption text using their computer device that may be relevant to the campaign directions, product or service provided by the merchant. In certain embodiments, the caption text entered may be a caption which endorses the merchant's associated product, service or campaign objective. The graphical user interface may provide a third portion of a Submit For Campaign page to enable a user to review the content item created: the photo taken, the picture uploaded, the video created and the caption entered. Preferred embodiments may provide a button SUBMIT PHOTO & CAPTION for the user to upload the content to the server element for approval by the administrator element.

In certain embodiments, the graphical user interface may provide a Post Campaign page to enable a user to post their content item directly to various social media server elements. Referring to FIG. 15 for illustration, preferred embodiments may provide a Approved page that enables a user to review their approved photo or video, and caption to post to a particular social media platform.

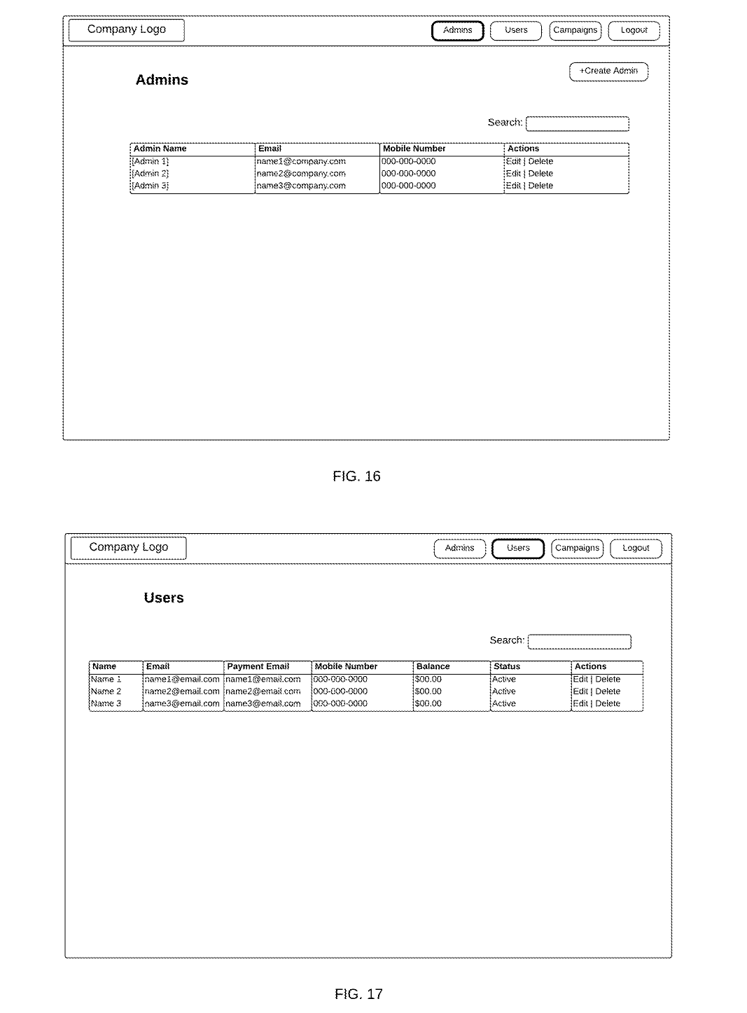

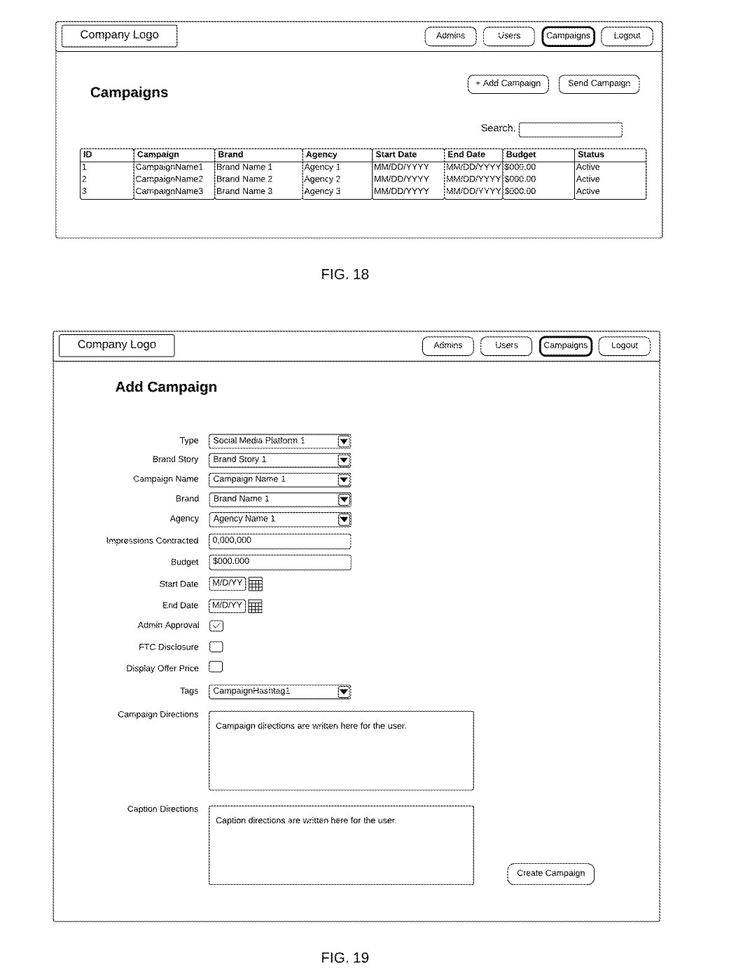

Referring to FIGS. 16-18 for illustration, preferred embodiments of a graphical administrator interface may provide an Admin page whereby the administrator element can create administrators, search and edit the administrator information inputted, for example, admin name, e-mail, mobile number, a combination thereof, or the like. In certain embodiments, the graphical administrator interface may also be configured to provide a Campaigns page where an administrative user can add a campaign, send a campaign to a user, view, search, select and edit merchant identification data regarding a current campaign. Further, preferred embodiments may provide a Users page where the administrator element may be able to view, search and edit tables of user uploaded content item data or user identification data.

Preferred embodiments may have an Add Campaign page where an administrator element may enter, upload and edit new campaign information such as, social media platform name, campaign name, brand story name, agency name, start and end date data, impressions contracted for, budget, admin approval, Federal Trade Commission (FTC) disclosure, campaign offer price, campaign hashtag, campaign directions, caption directions, a combination thereof, or the like. The graphical administrator interface may provide a fourth portion of an Administrative Dashboard page where an administrator element can view a table of pending campaigns earmarked for a select social media platform.

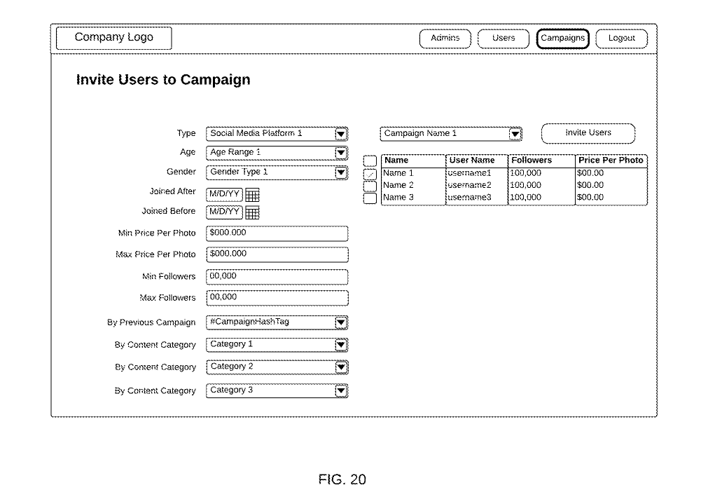

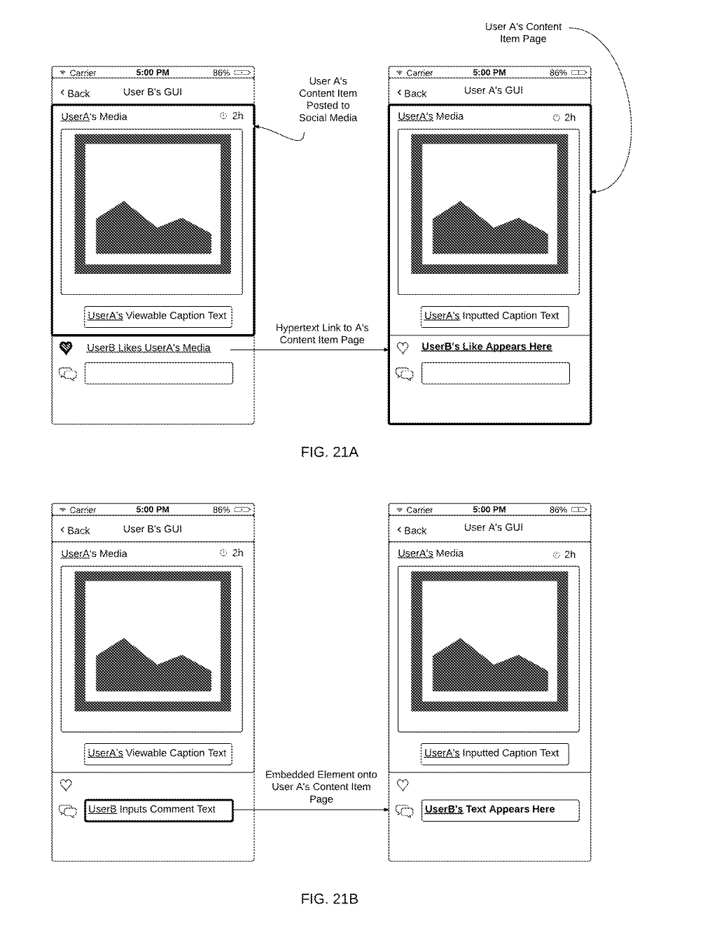

Referring to FIG. 20, preferred embodiments may provide an Invite Users to Campaign page enabling an administrator element to enter parameters of a marketing campaign, for example, the type of social media platform, age range demographic, gender type, joined before and after dates, minimum price per photo, maximum price per photo, minimum followers, maximum followers, by previous campaigns, by content categorical affinity, a combination thereof or the like. In preferred embodiments, an administrator element may pick a drop-down menu of campaign names, select the user and send an invitation inviting the user to participate in a campaign.

In certain embodiments, the graphical administrator interface may provide an Approval page that allows an administrative user to view, select or approve the promotions created for the marketing campaign. A further particular embodiment may have a graphical user interface that notifies the user that the submitted content item was approved and a button POST CAMPAIGN to enable the user to publish the promotion to various social media platforms. For example, a user may post a promotion to a social media platform where one or more of that user's followers or other users in general can view the promotion and input text or backlink to the content item.

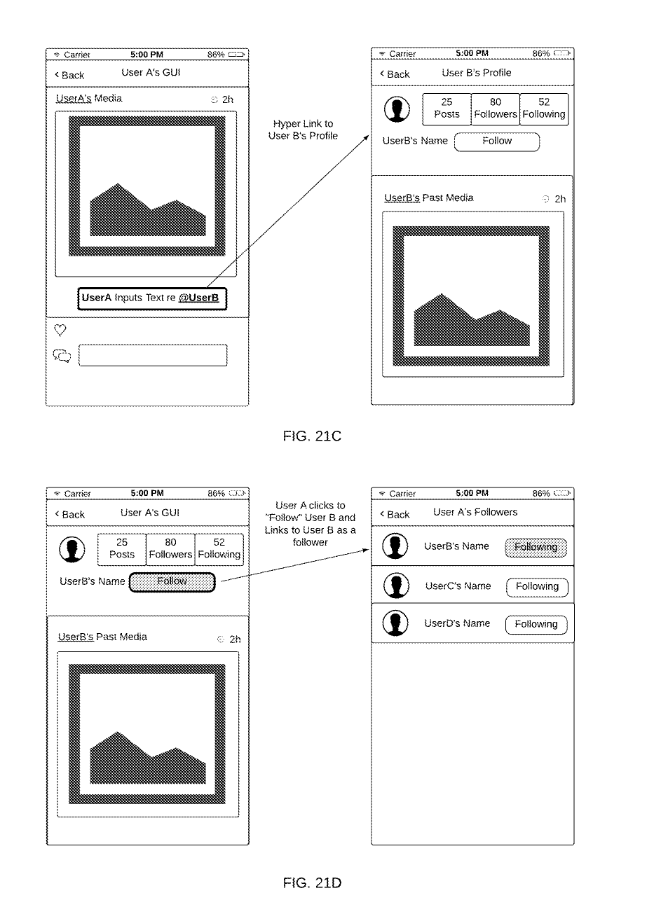

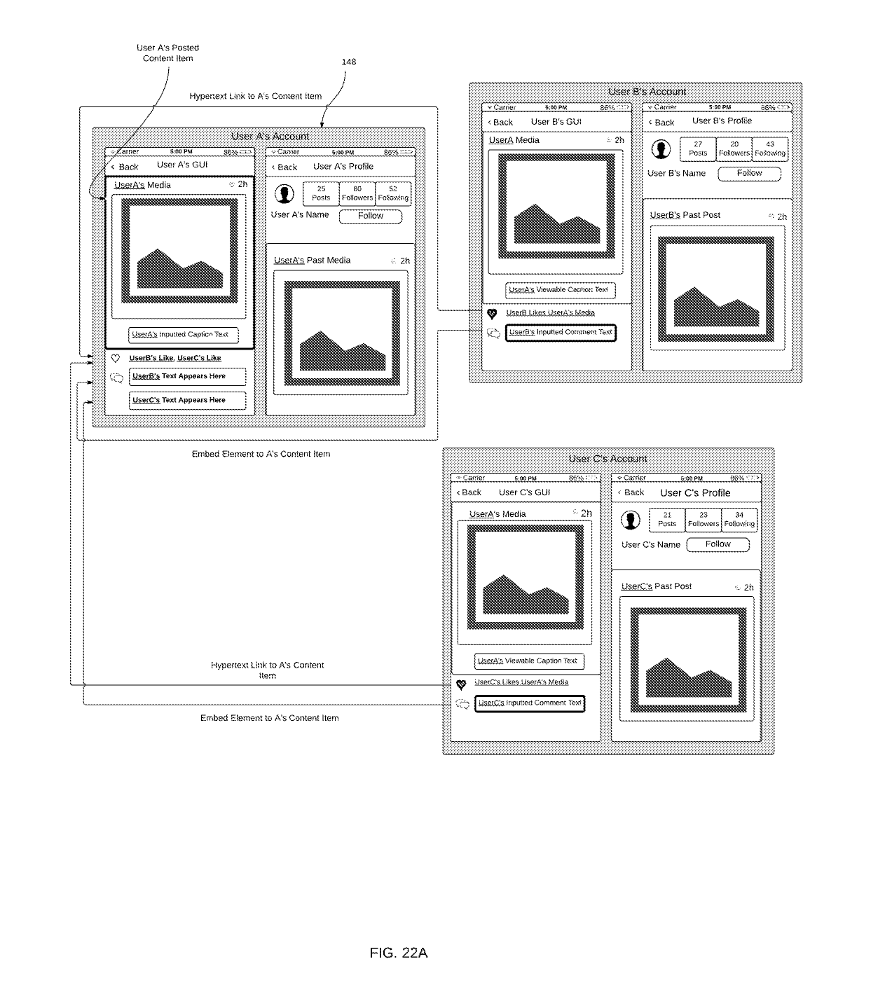

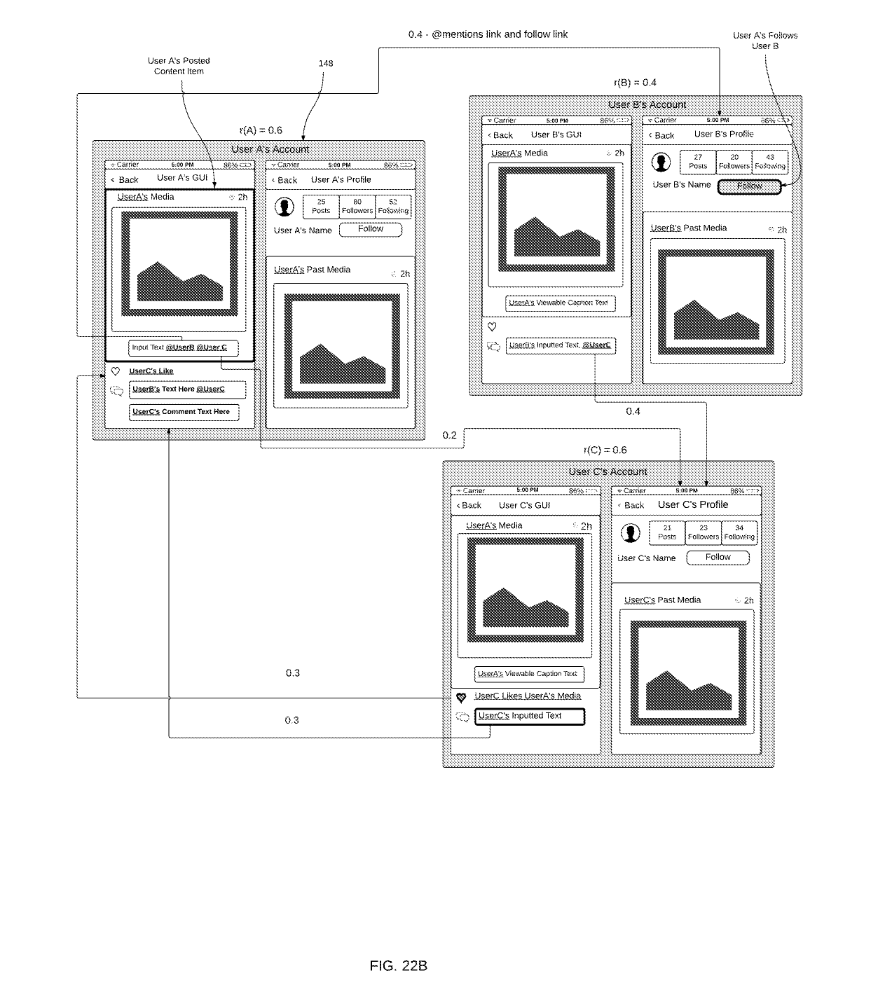

Referring to FIGS. 21-23 for illustration, one particular embodiment may provide the ranking of a linked and embedded document 148 of the present invention may be superficially similar to the well-known idea of citation ranking, the present method may be more subtle and complex than citation ranking and gives far superior results. In citation ranking, the rank of a document A may be simply determined by the backlinking pages of A, all of different weights, over a normalized number of links given a single probability that a web surfer will jump randomly to any page.

An embedded database (i.e., any database system of documents that tightly integrated with an application software and requires access to stored data, such that the system may be “hidden” from the application's end-user) may be represented as a directed graph of N vertices, where each vertex corresponds to a web or mobile application page document. In the directed graph, the directed connections between vertices may correspond to links from one document to another and the inputted text or content from one document to the other may correspond with an embed HTML element. A given vertex has a set of backward links that connect it to parent vertices, a set of forward links that connect it to subsidiary vertices, an HTML element that may be embedded into it by parent vertices, and an embedding HTML element inputted by it to a subsidiary vertex. For example, FIG. 21A diagrammatically illustrates a diagram depicting the relationship between two pages that are linked by a like. In preferred embodiments, a content item page may contain the user's media, photo, inputted caption text, @mentions, hyperlinks, tags, likes from other users, comments from other users, a combination of or the like. User B's like may be considered a backlink from User A's content item page. In preferred embodiments, User A may be interpreted as representing a first user, an influencer, or the like. Further, FIG. 21B diagrammatically illustrates a diagram depicting the relationship between two pages that have an embed element by comment. User B's comment text may be considered an embedded HTML element on User A's content item page.

FIG. 21C diagrammatically illustrates a diagram depicting the relationship between two pages that are forwardlinked by an @mention. User B's profile page may be forwardlinked by User A on User A's content item page using an @mention. Moreover, FIG. 21D diagrammatically illustrates a diagram depicting the relationship between two pages that may linked by a follow. User A may upon viewing User B's page link to User B by pushing the “Follow” button. User B may then follow or be followed by User A and depending on who follows who either user's content items will appear to the other user in their respective GUI.

FIG. 22A diagrammatically illustrates a first portion of a diagram depicting the relationship between three User Accounts and associated pages that may be linked by a like and embedded with HTML elements with a comment. User A's Account may been linked by User B and User C by a like and by a comment. In preferred embodiments, a like from User B on User A's content item contained on User A's content item page may be a backlink to User B's profile page. In certain embodiments, a embedded comment from User B on User A's content item contained on User A's post page may be HTML element signifying engagement with User A.

According to one embodiment of the present method of ranking, the likes from different pages may be weighted differently, the total number of likes of each document may be normalized, the comments from other users to User A may be weighted differently and the total number of comments on each page may be normalized. More particularly, the rank of a User A's Account may be defined according to the present invention as

$$r ( A ) = [ \frac{α}{N} + ( 1 - α ) ( \frac{r ( {B}_{1} )}{\vert {B}_{1} \vert} + … + \frac{r ( {B}_{n} )}{\vert {B}_{n} \vert} ) ] + b [ \frac{β}{N} + ( 1 - β ) ( \frac{r ( {E}_{1} )}{\vert {E}_{1} \vert} + … + \frac{r ( {E}_{m} )}{\vert {E}_{m} \vert} ) ]$$

where B₁, . . . , Bₙ may be the engaged users who liked User A's content item, r(B₁), . . . , r(Bₙ) may be the ranks of those liking users, |B₁|, . . . , |Bₙ| may be the number of @mentions, E₁, . . . , Eₙ may be the engaged users who commented on User A's content item, r(E₁), . . . , r(Eₙ) may be the ranks of those commenting users, |E₁|, . . . , |Eₙ| may be their number of comments embedded, a may be a constant in the interval [0,1], β may be a constant in the interval [0,1], N may be the total number of documents in the embedded database, and b may be an independent variable corresponding to a feature of relative power. Depending on particular embodiments, rank of User A's Account may be, for example,

$$r ( A ) = [ \frac{α}{N} + ( 1 - α ) ( \frac{r ( {B}_{1} )}{\vert {B}_{1} \vert} + … + \frac{r ( {B}_{n} )}{\vert {B}_{n} \vert} ) ] + b ( \frac{r ( {E}_{1} )}{\vert {E}_{1} \vert} + … + \frac{r ( {E}_{m} )}{\vert {E}_{m} \vert} ) ]$$

where B₁, . . . , Bₙ may be the engaged users who liked User A's content item, r(B₁), . . . , r(Bₙ) may be the ranks of those liking users, |B₁|, . . . , |Bₙ| may be the number of @mentions, E₁, . . . , Eₙ may be the engaged users who commented on User A's content item, r(E₁), . . . , r(Eₙ) may be the ranks of those commenting users, |E₁|, . . . , |Eₙ| may be their number of comments embedded, a may be a constant in the interval [0,1], β may be a constant in the interval [0,1], N may be the total number of pages in the embedded database, and b may be an independent variable corresponding to a feature of relative power. Similar to typical citation ranking, this definition may yield a User Account rank that increases as the number of backlinks increases. However, it also takes in to consideration that as the number of comments increase, so does the rank of each account. Additionally, not only does the present method consider a link from a highly ranked User Account as more important than a link from a lowly ranked User Account (provided both links come from backlinked pages that have an equal number of forward links) but also considers an embedded HTML element from a highly ranked User Account as more important than a link from a lowly ranked User Account (again, assuming both elements come from embedding pages that have an equal number of embedded elements). Thus, in embodiments of the present invention, it may be possible for a document with only one like and one comment (each coming from a very highly ranked User's Account) to have a higher rank than another User's Account with many likes and comments (all from very lowly ranked User Accounts). This may not be the case with typical citation ranking

The ranks can form a probability distribution over the User Accounts pulled by the embedded database, so that the sum of ranks over all User Accounts may be equivalent to unity. The rank associated with each User Account may be interpreted as the probability that a user will end up at the one of the documents contained after following a large number of likes and comments. The constant a in the formula may also be interpreted as the probability that a user will land randomly on any document contained with a User Account. The constant β in the formula may be interpreted as the probability that the user will randomly land on any document instead of choosing the document with a high number of embedded HTML elements. The ranks for all User Accounts in the embedded database may be calculated by iterating the algorithm, and may correspond to an eigenvector of the normalized matrix of the embedded database, as discussed below.

In order to illustrate the present method of ranking, consider the simple network of three User Accounts shown in FIG. 22B. For simplicity, we may assume here that r=0 and set b to 1.0 as a ratio power. User A's Account may have a single like from one of User C's pages (this may be the only forward link of User C) and may also be embedded with one comment from User C's pages (this may be the only embed element of User C), so

$$r ( A ) = \frac{r ( C )}{2} .$$

Referring to User A's Account relative to User B's Account, one of User B's pages may have a single @mention link to one of User C's pages, but this may be one @mention link as well as one follow link from User A, so

$$r ( B ) = \frac{2}{3} r ( A )$$

User C's Account may have two backlinks (e.g., two @mentions): one backlink may be from User B's Account (this may be an @mention of one of User B's pages). The other @mention may be from User A via one of User A's pages.

Referring to FIG. 22B for illustration, one particular embodiment could be

$$r ( C ) = r ( B ) + \frac{2}{3} r ( A )$$

and thus r(A)=0.6, r(B)=0.4, and r(C)=0.6, determined by inspection. Moreover, if for illustrative purposes, we may set ∝ and β to 0.5 (which corresponds to a 50% chance that a user will land on one of the three pages rather than following the forward links and a 50% chance a user will pick a document with a high number of embedded elements, respectively), then the relationships between the ranks become more complicated. Particularly, the resultant relationships are

$$r ( A ) = \frac{1}{6} + \frac{r ( C )}{4}$$

$$r ( B ) = \frac{1}{6} + \frac{1}{3} r ( A )$$

$$r ( C ) = \frac{1}{6} + \frac{1}{3} r ( A ) + \frac{r ( B )}{2}$$

The solution in this case may be r(A)=0.316, r(B)=0.366, and r(C)=0.566.

For practical application purposes, there can be millions of documents within a network and it is generally not possible to find the solution to a million queries by inspection. Consequently, in the preferred embodiment a simple iterative process may be used to compute larger collections of documents. An initial state can be set to all the ranks of 1/N and the formulas can be used to calculate a new set of ranks based on existing ranks To compute millions of documents may take up to 100 iterations of the formula. However, it may be not necessary to calculate the rank of every document with high precision. An approximate rank given two or more iterations can provide sufficient even superior information without the added expense of time.

A steady-state probability distribution can be represented from the above iterative procedure, modeled as if a random user would land on any of the documents. This model may be mathematically equivalent but a more concise description of the formula above. The model may include (a) an initial N-dimensional probability distribution vector p₀ where each component p₀[i] given the initial probability that a random user will start at vertice i, and (b) an N×N transition probability matrix A where each component A[i][j] gives the probability that the user will move from vertex i to vertex j. The probability distribution of the graph after the user follows one link may be p₁=Ap₀, and after two links the probability distribution may be p₂=Ap₁=A²p⁰. Assuming this iteration converges, it may converge to a steady-state probability

$${p}_{∞} = {lim}_{n -> ∞} {A}^{n} {p}_{0} ,$$

which may be a dominant eigenvector of A. The iteration may circulate the probability through the linked vertices like electricity flows through a circuit and accumulates in important places. Given that some pages may not have links nor any embedded HTML elements occur in significant numbers and may bleed off energy, complexities with computing rank value can occur. To address this problem, these dormant pages can be removed from the model in initial iterations and added back post-calculation. However, the number of iterations necessary to remove these pages originally may be determined to make sure they all receive a value. Alternatively, a small number of iterations can be used to estimate the steady state.

The rank r[i] of a vertex i can then be defined as a function of this steady-state probability distribution. For example, the rank can be defined simply by r[i]=p_{∞}[i]. This method of calculating rank may be mathematically equivalent to the iterative process as described above. Those skilled in the art will appreciate that this same method and can be characterized in various different way that may be mathematically equivalent. Such characterizations may be obviously within the scope of the present invention. Given the rank of various documents can vary by orders of magnitude, it may be convenient to define the rank on a logarithmic scale

$$r [ i ] = \frac{{p}_{∞} [ i ]}{\frac{min}{k ∈ [ 1 , N ]} \{ {p}_{∞} [ k ] \}} ,$$

which assigns a rank of 0 to the lowest ranked vertex and increases by 1 for each order of magnitude in importance higher than the lowest ranked vertex.

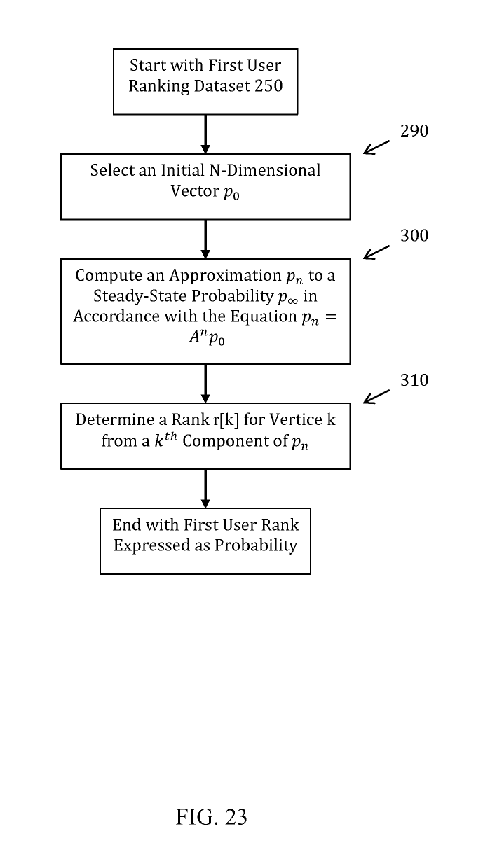

FIG. 23 shows one embodiment of a method for calculating a value rank for N linked or embedded vertices using a first user ranking dataset 250 of an embedded database. At step 290, an initial N-dimensional vector p₀ may be selected. An approximate pₙ to a steady-state probability p_{∞} in accordance with the equation pₙ=Aⁿp₀ may be computed at a step 300. Matrix A can be an N×N transition probability matrix having elements A[i][j] representing a probability of moving from vertex i to vertex j. At a step 310, a rank r[k] for vertex k from a k^{th} component of pₙ may be determined.

In one particular embodiment, a finite number of iterations may be performed to approximate p_{∞}. The initial distribution can be selected to be uniform or non-uniform. A uniform distribution would set each component of p₀ equal to 1/N. A non-uniform distribution, for example, can divide the initial probability among a few vertices which may be known a priori to have relatively large importance. This non-uniform distribution decreases the number of iterations require to obtain a close approximation to p_{∞} and also may be one way to reduce the effect of artificially inflating relevance by adding unrelated terms.

Real usage data, when available, can be used as a starting point for the model and as the distribution for the alpha factor. Further, once a set of documents may be identified that match the query, the documents may be then sorted and a value may be assigned to higher ranking documents first and lower ranking documents second. The ranking in this case may be a function which combines all of the above factors. If desired, the results can be grouped by category or feature as well.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for facilitating the distribution of electronically published promotions, the method comprising the steps of:
providing a server element to communicate between at a least a user and an administrator element;
providing an app for download via a network accessible app store, the app configured to be downloaded to a computing device of a user, the app configured to enable the user via a graphical user interface to:
upload to the server element user identification data unique to the user,
authorize the administrator element to access the user identification data,
view or select at least one marketing campaign associated with a merchant, the marketing campaign having campaign directions,
create or select at least one content item which relates to a product or service of the merchant, and which includes visually detectable media and a caption that are consistent with the campaign directions, and
upload to the server element the at least one content item for submission;
recording, in machine readable memory, the user identification data for access by the administrator element;
storing, in machine readable memory, the at least one content item for access by the administrator element;
computing, via a processor element, one or both of a user rank and campaign offer price based on the user identification data and the content item;
providing a graphical administrator interface configured to enable the administrator element to:
upload to the server element merchant identification data and marketing campaign information data, the marketing campaign information data including the campaign directions and a required link,
enter or approve the campaign offer price,
create a said marketing campaign incorporating at least part of the marketing campaign information data,
send the created marketing campaign to the user,
receive the at least one content item uploaded by the user,
review the at least one content item uploaded by the user,
approve at least one said reviewed uploaded content item, and
send at least one said approved uploaded content item to the user with said required link for publication;
wherein the server element is configured to:
confirm the said approved uploaded content item was published on at least a social media network server element, and
measure the performance of the said approved uploaded content item; and
wherein the graphical administrator interface is further configured to enable the administrator element to send a payment to the user.

2. A method as defined in claim 1 wherein the administrator element is a merchant, a merchant's agent, a second user or a second user's agent.

3. A method as defined in claim 1 wherein the administrator element is authorized to access a second user's identification data, the second user having engaged with the first user.

4. A method as defined in claim 1 wherein the content item is a photo or video that is selected from previously taken photos or videos, and the caption is text based.

5. A method as defined in claim 1 wherein the marketing campaign information data contains a second link to a document associated with the product or service of the merchant, and wherein the at least one content item created by the user incorporates the second link.

6. A method as defined in claim 1 wherein the step of computing involves a comparison between at least a portion of the user identification data and at least one content categorical affinity entered by the administrator element.

7. A system for facilitating the distribution of electronically published promotions, the system comprising:
a server element configured to be in communication between a user computing device, an administrator computing device and a social media network server element;
wherein the user computing device is configured to provide a graphical user interface to enable the user to:
upload to the server element user identification data,
authorize the administrator element to access the user identification data,
view or select at least one marketing campaign associated with a merchant, the marketing campaign having campaign directions,
create or select at least one content item that includes visually detectable media and which includes a caption by the user relevant to:
the campaign directions, a product or a service of a merchant, and
upload to the server element the at least one content item;
wherein the server element is configured to record, in machine readable memory, the user identification data for access by the administrator element;
wherein the server element is configured to store, in machine readable memory, the at least one content item for access by the administrator element;
wherein the administrator computing device is configured to present a graphical administrator interface to enable the administrator element to:
upload to the server element merchant identification data and marketing campaign information data,
create a marketing campaign incorporating at least part of the marketing campaign information data,
enter a campaign offer price,
view, select or approve at least one said uploaded content item,
send at least one approved uploaded content item to the user incorporating at least part of the marketing campaign information;
wherein the server element is configured to:
confirm the approved uploaded content item was published on at least a social media network server element, and
measure the performance of the approved uploaded content item data; and
wherein the administrator computing device is configured to present a graphical administrator interface to enable the administrator element to send payment to the user.

8. A system as defined by claim 7 wherein the administrator element is further defined has a merchant, a merchant's agent, a second user or a second user's agent.

9. A system as defined by claim 7 wherein the content item is a photo, video or text based caption.

10. A system as defined by claim 7 wherein the marketing campaign information data further identifies the campaign directions and associated caption to be included by the user.

11. A system as defined by claim 7 wherein the marketing campaign information data further identifies caption directions and a required hypertext link.

12. A system as defined by claim 7 wherein the content item approved is related to a sales promotion, advertisement, sweepstakes or contest associated with a business, product or service of the merchant.

13. A system as defined by claim 7 wherein the user identification data includes at least one content categorical affinity of the user.

14. A system for facilitating the ranking of a plurality of linked and embedded documents, the system comprising:
machine-readable memory configured for storage of first user data of a registered first user, linked document data, linking document data, first weighting factor data, embedded element document data, embedding element document data, second weighting factor data, and input variable data, wherein:
the first user data includes a first user identification data;
the linked document data includes a backlink count from a second user document of a second user;
the linking document data corresponds to a forward link count from the second user document;
the first weighting factor data is provided by an administrator element and includes a factor as applied to a backlink or forward link amount;
the embedded document data includes the amount of embedded elements input by the second user;
the embedding document data corresponds to the inputting second user's identification data and content item data;
the second weighting factor data provided by the administrator element includes a factor as applied to the embedded element amount;
the input variable data corresponds to an input variable as provided by the administrator element;
a processor element configured to communicate with the machine-readable memory;
one or more logic applications executable by the processor element and containing instructions which, when executed by the processor element, configure processor element to:
generate a document ranking dataset;
perform a step of calculating; and
perform a step of assigning;
wherein the document ranking dataset is electronically accessible to the administrator element and includes one or more of:
the ranking data set for the registered first user corresponding to data from at least a previously published content item page, and
the ranking data set of at the second user corresponding to data from at least a previously published content item page,
wherein for the step of calculating, the processor element is configured to calculate document rank based upon at least,
the ranking data set for the first user document,
the ranking data set for at least the second user document,
resulting in the adjusted rank of each of the one or more linked and embedded documents, and
wherein for the step of assigning, the processor element is configured to assign a rank to one or more linked and embedded documents based on ranks of the one or more linking or embedding documents.

15. A system as defined by claim 14 wherein the documents include web documents, web pages, mobile pages, user profile pages or content item hosting pages.

16. A system as defined by claim 14 wherein the linked document data includes the second user's identification data and content item data.

17. A system as defined by claim 14 wherein the linking document data includes the second user's identification data and content item data.

18. A system as defined by claim 14 wherein the embedded document data includes the count of comment text or HTML embedded element inputted by the second user on the first user's document.

19. A system as defined by claim 14 wherein the ranking data set for the registered first user includes an offer price for the first user.

20. A system as defined by claim 14 wherein the ranking data set for the registered first user includes an offer price for the first user based upon a comparison with at least one content categorical affinity.

21. A system as defined by claim 14 wherein the identified weighting factor is represented as an integer, whole number or decimal.

22. A system as defined by claim 14 wherein first user identification data includes at least one content categorical affinity.

23. A method for ranking a plurality of linked and embedded documents, the method comprising the steps of:
obtaining a plurality of documents,
at least some of the documents being linked documents,
at least some of the documents being linking documents,
at least some of the documents being both linked documents and linking documents,
each of the linked documents being pointed to by a link in one or more of the linking documents,
at least some of the documents having embedded elements, at least some of the documents having embedding elements,
at least some of the documents having both embedded and embedding elements,
each of the embedded documents containing an element from one or more of the embedding documents;
calculating a rank of each of the linked and embedded documents based on ranks of the one or more linking or embedding documents; and
assigning a rank to the linked and embedded documents according to their calculated ranks

24. A method as defined in claim 23 wherein the documents include web documents, web pages, mobile pages, user profile pages and content item hosting pages.

25. A method as defined in claim 23 wherein the calculating includes:
identifying a weighting factor for each of the linking or embedding documents, the weighting factor being dependent on an estimation of a probability that a linking document will be accessed, and
adjusting the rank of each of the one or more linking documents based on the identified weighting factor.

26. A method as defined in claim 23 wherein the calculating includes:
identifying a weighting factor for each of the linking or embedding documents, the weighting factor being dependent on an estimation of a probability that an embedding document will be accessed, and
adjusting the rank of each of the one or more linking documents based on the identified weighting factor.

27. A method as defined in claim 23 wherein the calculating includes:
identifying a weighting factor for each of the linking or embedding documents, the weighting factor being dependent on the number of links and embedded HTML elements to the one or more linking documents, and
adjusting the rank of each of the one or more linking documents based on the identified weighting factor.

28. A method as defined in claim 23 wherein the calculating includes:
identifying a weighting factor for each of the linking or embedding documents, the weighting factor being dependent on the number of links and embedded HTML elements to the one or more embedding documents, and
adjusting the rank of each of the one or more embedding documents based on the identified weighting factor.

29. A method as defined in claim 23 wherein the calculating includes:
identifying a weighting factor for each of the linked and embedded documents, the weighting factor being dependent on input variables provided by the administrator element, and
adjusting the rank of each of the one or more linking documents based on the identified weighting factor.

30. A method as defined in claim 23 wherein the calculating includes:
identifying at least one content categorical affinity for each of the linked and embedded documents, and
adjusting the rank of each of the one or more linked and embedded documents based on the identified content categorical affinity.
